(19) United States
(12) Patent Application Publication
(10) Pub. No.: US 2006/0273478 A1
(43) Pub. Date: Dec. 7, 2006

(54) Method of manufacturing a high sag lens and a lens manufactured by using the same method

(76) Inventors: Young Su Jin, Hwasung (KR); Ho Seop Jeong, Sungnam (KR); Dong Ik Shin, Suwon (KR)

Correspondence Address: LOWE HAUPTMAN BERNER, LLP, 1700 DIAGONAL ROAD, SUITE 300, ALEXANDRIA, VA, 22314, US

(21) Appl. No.: 11/403,805

(22) Filed: Apr. 14, 2006

(30) Foreign Application Priority Data
Jun. 3, 2005 (KR) 10-2005-48006

(51) Int. Cl. B29D 11/00

(52) U.S. Cl. 264/1.32; 264/1.38; 264/1.7

(57) ABSTRACT

The invention provides a method of manufacturing a high sag lens and a lens manufactured thereby. According to the invention, in manufacturing a lens, a polymer lens section made of ultraviolet cured resin is formed on a substrate. Polymer is injected into a mold having a plurality of grooves and then cured by ultraviolet ray to form a plurality of lens sections. Thereafter, a substrate is adhered integrally to a back side of the lens section. Finally, the mold is released from the lens section to produce a lens array. The invention eliminates a need to correct a lens surface resulting from polymer shrinkage and enhances quality of the lens. Also, the invention allows manufacture of the lens without repeating a replication method and dramatically increases work productivity.

### CLAIM OF PRIORITY

This application claims the benefit of Korean Patent Application No. 2005-48006 filed on Jun. 3, 2005 in the Korean Intellectual Property Office, the disclosure of which is incorporated herein by reference.

### BACKGROUND OF THE INVENTION

1. Field of the Invention

The present invention relates to a method of manufacturing a high sag lens and a lens manufactured thereby. More particularly, the present invention relates to a method of manufacturing a high sag lens which enhances lens quality without any need to correct a lens surface resulting from polymer shrinkage, and drastically increases work productivity due to its manufacture without repeated replication, and a lens manufactured thereby.

2. Description of the Related Art

Conventionally, a lens array was directly produced via laser beam or formed by an etching or reflow method using a pattern. A lens array was used to fabricate a Ni master mold via Ni electro-plating. Then the Ni master mold was employed to produce the lens array by replication or molding.

Alternatively, a diamond turning machine (DTM) was used to fabricate an array of the lens mold. Then replication or molding was applied to produce a lens array. But such conventional methods have limitations as described below.

That is, in processing a mold via laser beam, a manufacturable lens sag is directly proportional to the depth of a photo resister (PR) layer formed after spin coating. This renders it difficult to manufacture a high sag or a sag having a height of hundreds of μm.

Also, in processing a mold via laser beam, an aspheric surface is hardly attainable and has limits in manufacturing the aspheric surface.

Further, as shown in FIG. 1, to form a high sag lens 200, it should be molded by repeated replication. But in case where a lens section 210 is formed on a substrate 205 by repeated replication of at least twice, an entire process such as polymer drop, compression, UV curing and release of repeated replication require a considerable amount of work time.

Moreover, the replication method requires additional molds (not illustrated) having different numeric aperture (NA) values applied to each molding layer 210a, 210b, 210c of a lens.

Meanwhile, FIG. 2 shows a conventional process 300 of producing a lens array in which a photo polymer is coated onto a metal plate for one time, covered by a substrate and then cured.

In this conventional method, first, a photo polymer 310 is dropped onto a microlens array (MLA) mold 302. A transparent substrate 315 is adhered to the photo polymer 310 to form a lens section. Then ultraviolet ray is irradiated through the substrate 315 to cure the photo polymer 310. Thereafter, the MLA mold 302 is released from a lens section to produce a lens array.

FIG. 3 illustrates a different process 400 of fabricating a lens array.

According to such prior art technique, first, a mold 405 having a groove 450a corresponding to a convex lens is prepared. UV cured resin is coated onto the groove of the mold 405 to form a lens section 410. Then a substrate 412 is adhered to a back side of the mold, and ultraviolet ray is irradiated through the substrate 412 to cure UV cured resin. Thereafter, the mold 405 is removed to obtain a lens section 410 made of an UV cured resin and a substrate 412. The lens section 410 and the substrate 412 are arranged repeatedly in parallel to produce a lens array (MLA) 420.

However, such conventional technologies have problems in a manufacturing process. As shown in FIG. 4, curing of polymer begins from the substrate 315, 420 and then spreads to a lens surface P, which is farthest from the substrate 315, 420. Therefore in case of completed curing, polymer contracts most intensively on the spherical lens surface P. This leads to defective curvature and form. Also, during curing of polymer of the lens section, bubbles may build up. Bubbles, if generated, do not exit to the outside due to the transparent substrate 315, 412 but remains in the lens section 320, 410, potentially degrading the lens quality.

### SUMMARY OF THE INVENTION

The present invention has been made to solve the foregoing problems of the prior art and it is therefore an object of the present invention to provide a method of manufacturing a high sag lens, which does not require correction of a lens surface by ensuring polymer shrinkage to occur in a region other than the lens surface and significantly enhances lens quality by preventing bubbles from remaining in the lens, and a lens manufactured thereby.

According to an aspect of the invention for realizing the object, there is provided a method of manufacturing a high sag lens by forming a polymer lens section made of an ultraviolet ray cured resin on a substrate, the method comprising steps of:

(i) injecting polymer into a groove on a mold and curing the polymer with ultraviolet ray to form a lens section;

(ii) adhering a substrate integrally to a back side of the lens section; and

(iii) releasing the mold from the lens section to produce a lens.

Preferably, according to another aspect of the invention for realizing the object, there is provided a method of manufacturing a high sag lens wherein in the step (i), the lens section is cured in air or in oxygen atmosphere.

Preferably, according to further another aspect of the invention for realizing the object, there is provided a method of manufacturing a high sag lens wherein the step (i) comprises injecting polymer into the groove on the mold and curing the polymer repeatedly.

Preferably, according to further another aspect of the invention for realizing the object, there is provided a method of manufacturing a high sag lens wherein an adhesive used in the step (ii) comprises a composition identical to polymer of the lens section.

Preferably, according to further another aspect of the invention for realizing the object, there is provided a method of manufacturing a high sag lens wherein an adhesive used in the step (ii) comprises a composition with similar optical properties to polymer of the lens section.

Preferably, according to yet another aspect of the invention for realizing the object, there is provided a method of manufacturing a high sag lens wherein the step (ii) comprises curing the polymer by ultraviolet ray irradiated through the substrate.

According to another aspect of the invention for realizing the object, there is provided a lens manufactured according to a method as described above.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a detailed sectional view of a high sag lens according to the prior art;

FIG. 2 is an explanatory view illustrating, in a stepwise fashion, a method of manufacturing a lens according to the prior art;

FIG. 3 is an explanatory view illustrating, in a stepwise fashion, a method of manufacturing a lens via a different process according to the prior art;

FIG. 4 is an explanatory view illustrating a sequence of lens section curing in a method of manufacturing a lens according to the prior art;

FIGS. 5 (a) to 5(c) are explanatory views illustrating, in a stepwise fashion, a method of manufacturing a high sag lens according to an embodiment of the invention;

FIG. 6 is an explanatory view illustrating a sequence of curing a lens section in the method of manufacturing a lens of the invention;

FIGS. 7a to 7c are explanatory views illustrating, in a stepwise fashion, a method of manufacturing a sag lens according to another embodiment of the invention; and

FIG. 8 is a detailed sectional view illustrating a high sag lens obtained according to the manufacturing method of the invention

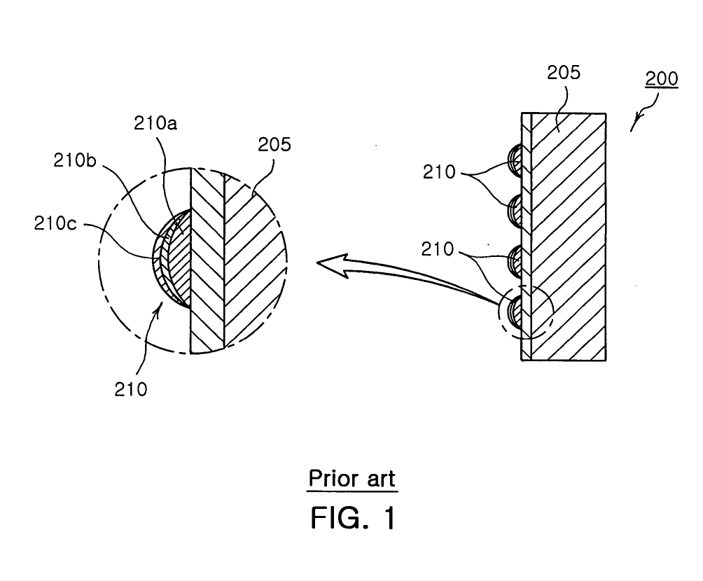

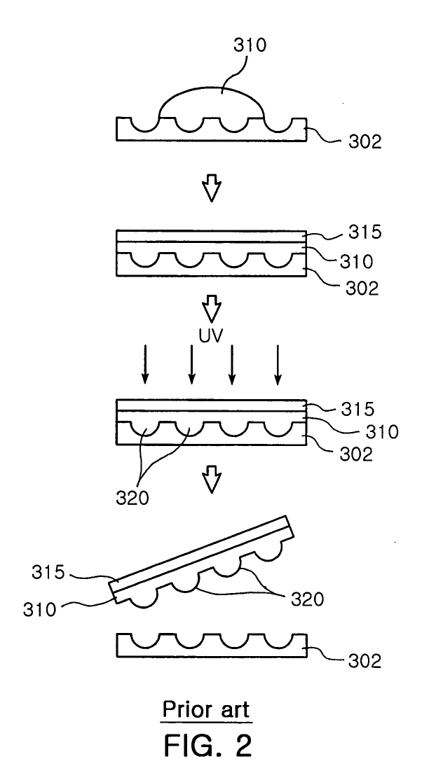

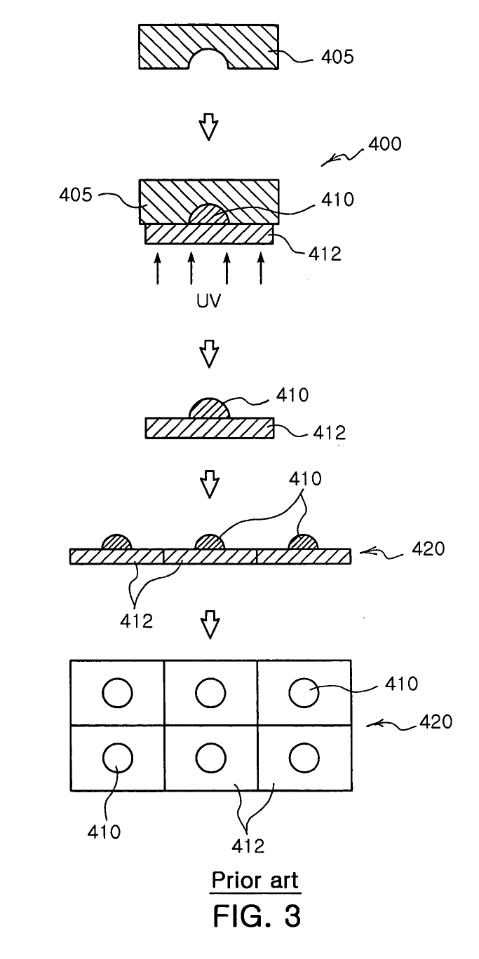

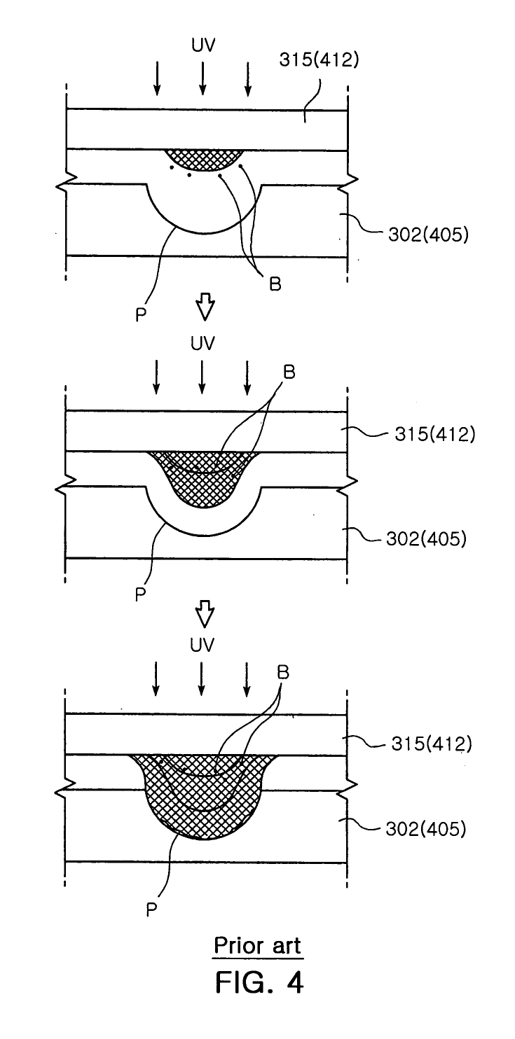

### DETAILED DESCRIPTION OF THE PREFERRED EMBODIMENT

Preferred embodiments of the present invention will now be described in detail with reference to the accompanying drawings.

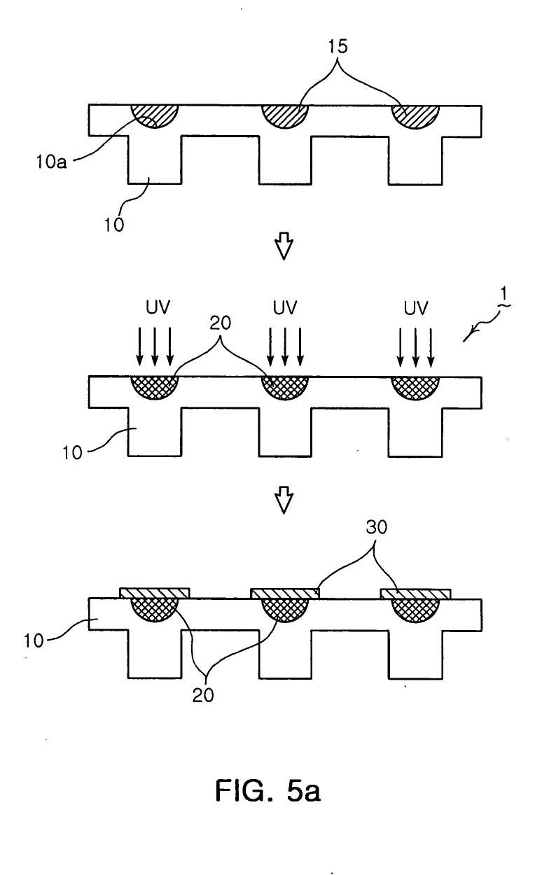

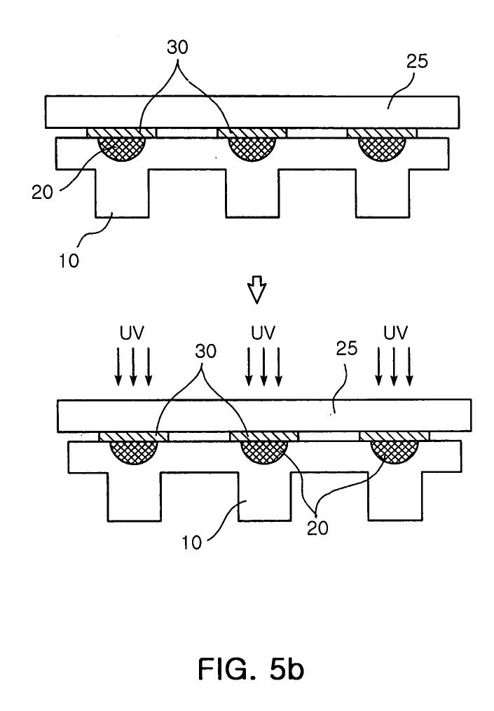

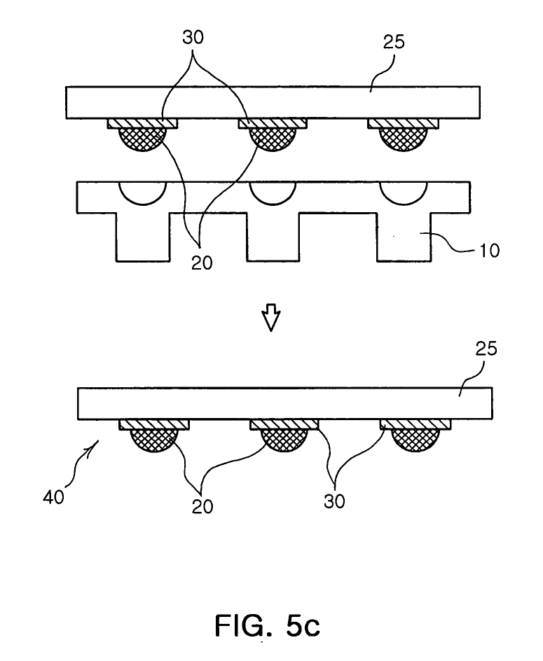

In a method of manufacturing a high sag lens (designated with the reference sign 1) according to the invention, as shown in FIGS. 5a to 5c, first, polymer 15 is injected into a mold 10 having a plurality of grooves 10a and cured by ultraviolet ray to form a plurality of lens sections 20 (see FIG. 5a). The mold 10 is machined by a diamond turning machine (DTM), which ensures easy manufacture of an aspherical lens and enables manufacture of a high sag lens. That is, the grooves 10a formed on the mold 10 have a depth of hundreds of μm, and thus just one molding allows a depth of a high sag lens at one time.

Further, polymer 15, which is injected into the mold 10, is cured by ultraviolet ray with its surface exposed to air. In this case, polymer positioned in the grooves 10a of the mold 10 is cured most slowly at an interface with air. This is because radical reaction is restrained due to aerial oxygen (O₂) at an interface with air. That is, the interface of the lens sections 20 exposed to the air undergoes the slowest curing owing to the reaction with oxygen. That is why polymer 15 contracts on an exposed surface P′ but not on a lens surface P.

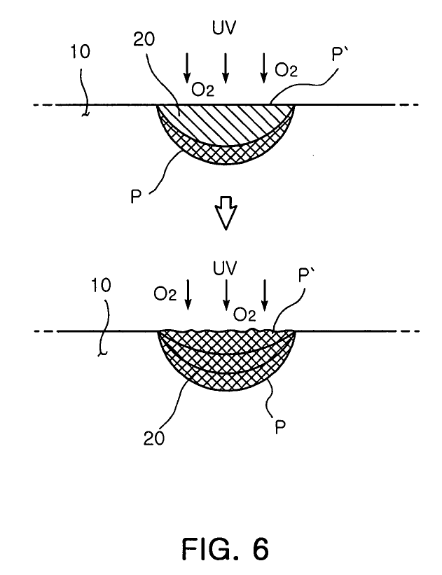

In other words, as shown in FIG. 6, curing starts from a lens surface P which contacts a groove 10a of the mold 10 and then to an exposed surface P′ of a lens section 20. Polymer contraction caused during curing is transferred to the exposed surface P′ of the lens section 20 which is not yet cured. As a result, the lens section 20 is finally cured with the exposed surface P′ suffering from polymer shrinkage.

Also, bubbles which may build up inside the lens section 20 during such a process can freely exit to the outside through the exposed surface P′. Therefore bubbles generated during curing of the lens section 20 do not remain inside.

According to description as above, the exposed surface P′ of the lens section 20 is exposed to air. But the invention is not limited thereto and the exposed surface P′ can be exposed in an oxygen atmosphere which ensures effects equal to air.

In addition, according to the invention as stated above, the lens section 20 is formed in the groove 10a on the mold 10 through just one molding, but the invention is not limited thereto. If necessary, polymer may be split-injected into the grooves 10a of the mold 10 and repeatedly cured by ultraviolet ray to form the lens section 20.

Then, according to the invention, a substrate 25 is adhered integrally to the lens section 20 (see FIG. 5b).

To do this, according to the invention, an adhesive polymer 30 is coated onto the lens section 20. The adhesive polymer 30 has a composition identical to the polymer 15 of the lens section 20 or has a composition with similar optical properties to the polymer 15.

For example, the optical properties include refractivity or Abbe number (reciprocal dispersion index). The adhesive polymer 30 is coated in a liquid state onto an uneven configuration of an exposed surface P′ of the lens section 20 resulting from polymer shrinkage. Thereby, such unevenness of the exposed surface P′ is corrected.

Then, a transparent substrate 25 is adhered to the adhesive polymer 30. Ultraviolet ray is irradiated to the transparent substrate 25 so that the adhesive polymer 30 is cured and adhered integrally to the substrate 25.

In this process, the adhesive polymer 30 may contract during curing, causing bubbles to remain inside. But due to a small amount of the adhesive polymer 30 and its thickness of μm, the polymer shrinkage and bubble generation do not affect quality of the lens section 20.

Thereafter, according to the invention, the mold 10 is separated from the lens section to manufacture a lens array (see FIG. 5c).

In this step, the mold 10 is released from the lens section 20 to produce the lens array 40 having a plurality of lens sections 20 arranged on the side of the substrate 25.

In the method of manufacturing the high sag lens 1 according to the invention as described above, the mold 10 having deep grooves 10a formed by the DTM is used to form the lens. This leads to formation of the high sag lens in a single process. Therefore, this eliminates a need for a repeated replication method of forming two- or three plies of molding layers, and subsequently a need for additional molds 10 having different forms.

Also, deformation caused by polymer contraction takes place not on a lens surface P but on other parts, that is, an exposed surface P′. Therefore, there is no need to correct any deformation of the lens surface P, and resultantly enhances quality of the lens section 20 and work productivity.

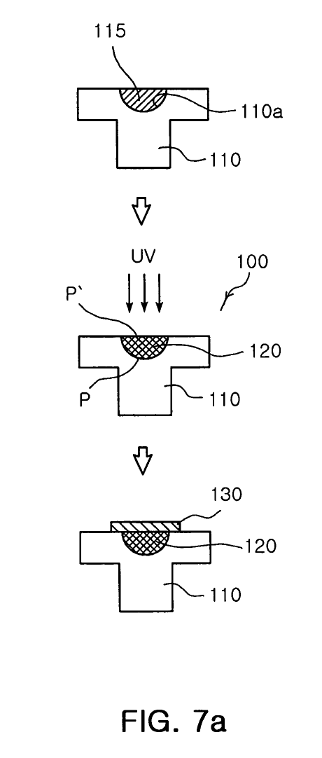

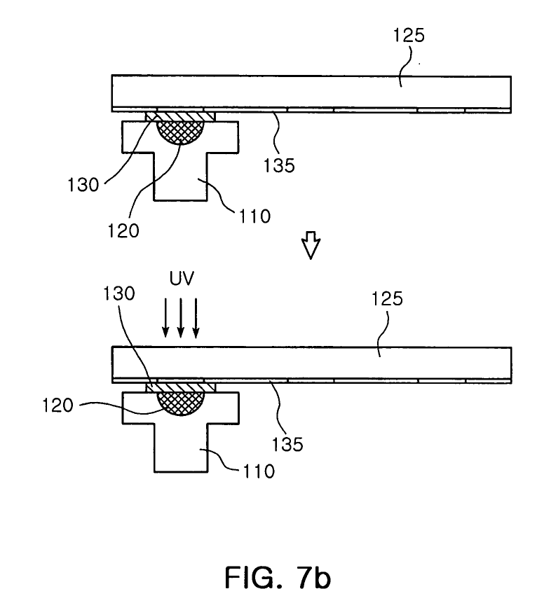

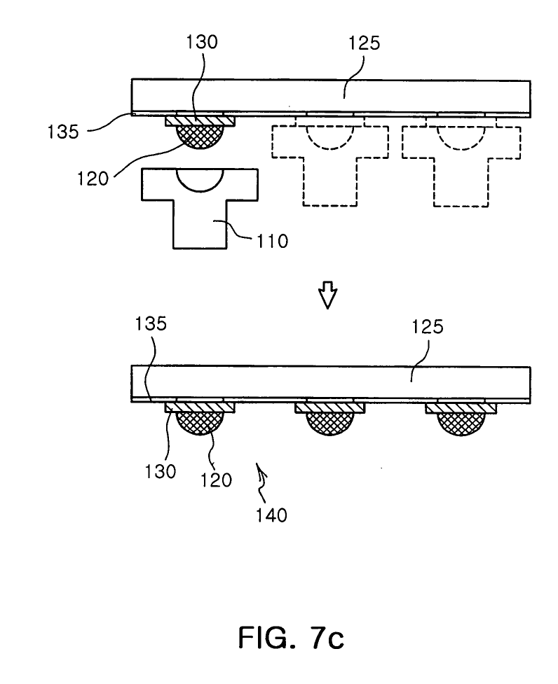

FIG. 7 shows a method of manufacturing a high sag lens 100 according to another embodiment of the invention. In this manufacturing method 100, first, a polymer 115 is injected into grooves 110a of a mold 110 and cured by ultraviolet ray to form lens sections 120 (see FIG. 7a).

In this step, as explained with reference to FIGS. 5a to 5c, the mold 110 is machined by a DTM, which allows easy manufacture of an aspheric lens, and enables formation of a greater depth of sag and thus manufacture of a high sag lens.

Then, polymer 115 is injected into the grooves 110a of the mold 110 and cured by ultraviolet ray with its surface exposed to air. In this process, polymer inside the grooves 110a of the mold 110 is most slowly cured at the interface with air due to restrained radical reaction with oxygen.

Therefore, shrinkage caused during curing of polymer 115 is transferred toward an exposed surface P′ which is not yet cured. The lens section 120 is finally cured with its exposed surface P′ suffering from shrinkage. Consequently, such exposed surface P′ is deformed. Moreover, bubbles which may build up inside the lens section 120 in this process freely exit to the air through the exposed surface P′ without remaining inside

According to the invention, as explained above, the lens section 120 is formed in the grooves 110a of the mold through just one molding process. But the invention is not limited thereto. In case of a much higher sag, polymer may be split-injected into the grooves 110 of the mold and cured repeatedly by ultraviolet ray to form the lens section 120.

Thereafter, a substrate is adhered integrally to a back side of the lens section 120 (see FIG. 7b). In this step, as described regarding FIGS. 5a to 5c, the lens section 120 of the mold 110 is coated with an adhesive polymer 130 having a composition identical to polymer 115 of the lens section 120. The adhesive polymer 130 is adhered to a predetermined position of the substrate 125. In this process, the adhesive polymer 130 is coated in a liquid state, thereby correcting unevenness of the exposed surface P′.

The lens section 120 coated with the adhesive polymer 130 is arranged in a predetermined position from an alignment layer 135 which is formed on a side of the substrate 125.

The alignment layer 135 is a thin-film layer pre-formed on the substrate 125. The alignment layer serves as a marker for arranging the lens section 120 in a predetermined position. Due to considerable thinness of the alignment layer 135, in case where the mold 110 having the lens section 120 is adhered to the substrate 125 via the adhesive polymer 130, the alignment layer 135 does not affect the amount of the adhesive polymer 130 adhered to the lens section 120. Thus, the alignment layer 135 only serves as a marker for arrangement.

Through this process, a transparent substrate 125 is adhered to the adhesive polymer 130. Ultraviolet ray is irradiated through the transparent substrate 125 so that the adhesive polymer 130 is cured and adhered integrally to the substrate 125.

Even in the curing process stated above, the adhesive polymer 130 may shrink, causing bubbles to remain inside. However, owing to a small amount of the adhesive polymer 130 and its thickness of μm, such shrinkage and bubble generation do not affect quality of the lens section 120.

Then, according to the invention, the mold 110 is removed from the lens section 120 to produce a lens (see FIG. 7c). That is, the mold 110 is released from the lens section 120, leaving the lens section 120 on a side of the substrate 125.

Thereafter, in a repetition of the steps in FIGS. 7a to 7c, a plurality of lens sections 120 are adhered integrally to the substrate 125 to produce a lens array 140 (see a lower part of FIG. 7c). That is, in repetitive processes, polymer 115 is injected into the grooves 110a of the mold 110 and cured by ultraviolet ray to form the lens sections 120; the substrate is adhered integrally to a back side of the lens sections 120 and the mold 110 is released from the lens sections 120. Then the lens sections 120 are adhered to the substrate 125 on the basis of the alignment layer 135 to form the aligned lens array 140.

Through this process, the invention eliminates needs to correct an uneven lens surface P resulting from polymer contraction and to repeat a replication method. In addition, additional molds with different forms are not required. Consequently, the invention ensures very high productivity and enables manufacture of a high-quality high sag lens.

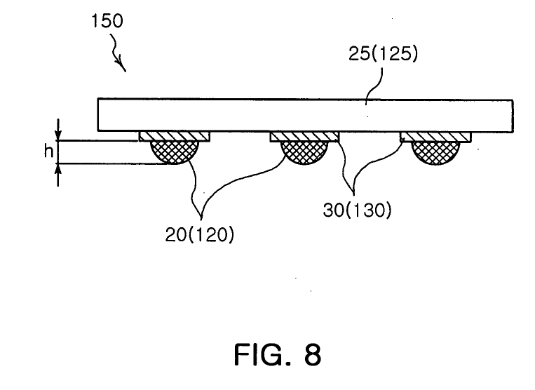

FIG. 8 shows a high sag lens 150 obtained by a method of manufacturing a high sag lens 1, 100 of the invention.

The lens 150 includes lens sections 20, 120 formed by injecting polymer 15, 115 into a mold 10 and curing the polymer 15, 115 by ultraviolet ray; a substrate 25, 125 having the lens sections 20, 120 arranged on the side; and an adhesive layer 30 which adheres the lens sections 20, 120 integrally to the substrate 25, 125. As shown in FIG. 8, the lens sections 20, 120 are arranged on the substrate 25, 125 in a structure of a lens array. The invention is not limited thereto, but a single lens having a lens section formed on a substrate can be manufactured according to the invention.

As shown in FIG. 8, in the high sag lens 150 of the invention, the lens sections 20, 120 have a sag or height h of hundreds of μm. Polymer 15, 115 of the lens sections 20, 120 has a composition identical to polymer of adhesive layers 30, 130. Therefore, after curing, no boundary surface is formed between the adhesive layers 30, 130 and the lens sections 20, 120.

Also, to form the lens sections 20, 120 just one molding in grooves 10a, 110a of the mold 10, 110 is required, or if necessary, polymer is split-injected into the grooves on the mold and cured repeatedly by ultraviolet ray. Unevenness of an exposed surface P′ of the lens section 20, 120 caused during curing is corrected in the forming of the adhesive layers 30, 130.

Therefore, the lens surface P does not have any deformation resulting from shrinkage of polymer 15, 115. In addition, the high sag lens of the invention exhibits superior quality due to no bubbles present in the lens sections 20, 120.

According to the invention, a Ni master mold can be attained by applying Ni electro-plating to the lens array obtained by the method of manufacturing the high sag lens of the invention.

That is, conventionally the lens array was formed directly via laser beam or by an etching or reflow method using a pattern. Then the lens array was used to manufacture the Ni master mold by a Ni electro-plating. However, the Ni master mold for manufacturing a high sag lens is simply produced by applying Ni electro-plating to the lens array obtained by the method of manufacturing a high sag lens of the invention.

According to the invention as set forth above, in manufacturing the high sag lens, the mold machined by the DTM is used to form the high sag lens in a single process. Also, due to curing conducted during exposure to air, radical reaction is restrained by oxygen and thus polymer contraction occurs in a region other than a lens surface. This renders it unnecessary for the lens surface to be corrected.

Further, bubbles which may build up during polymer curing are prevented from remaining inside the lens section, consequently boosting quality of the lens significantly.

The invention obviates a need for a repeated replication method such as a plurality of polymer drop, compression, UV curing, and release or for additional molds with different forms. Also, the invention ensures manufacture of the lens array via a simple process, thereby dramatically increasing productivity in manufacturing the high sag lens.

Further, according to the invention, the Ni master mold for manufacturing the high sag lens can be easily attained by applying Ni electro-plating to the lens array obtained as above.

While the present invention has been shown and described in connection with the preferred embodiments, it will be apparent to those skilled in the art that modifications and variations can be made without departing from the spirit and scope of the invention as defined by the appended claims.

What is claimed is:

1. A method of manufacturing a high sag lens by forming a polymer lens section made of an ultraviolet ray cured resin on a substrate, the method comprising steps of:
(i) injecting polymer into a groove on a mold and curing the polymer with ultraviolet ray to form a lens section;
(ii) adhering a substrate integrally to a back side of the lens section; and
(iii) releasing the mold from the lens section to produce a lens.

2. The method according to claim 1, wherein in the step (i), the lens section is cured in air or in oxygen atmosphere.

3. The method according to claim 1, wherein the step (i) comprises injecting polymer into the groove on the mold and curing the polymer repeatedly.

4. The method according to claim 1, wherein an adhesive used in the step (ii) comprises a composition identical to polymer of the lens section.

5. The method according to claim 1, wherein an adhesive used in the step (ii) comprises a composition with similar optical properties to polymer of the lens section.

6. The method according to claim 1, wherein the step (ii) comprises curing the polymer by ultraviolet ray irradiated through the substrate.

7. A lens manufactured according to a method as described in claim 1.
